(19) United States
(12) Patent Application Publication
(10) Pub. No.: US 2025/0194635 A1
(43) Pub. Date: Jun. 19, 2025

(54) HYDRATION SYSTEMS WITH ADJUSTABLE AGITATION FEATURES

(71) Applicant: Seattle Food Tech, Inc., Seattle, WA (US)

(72) Inventors: Julia O'Donnell, Seattle, WA (US); Justin Cassidy, Seattle, WA (US); Christina Zeigler, Seattle, WA (US); Brian Cichy, Seattle, WA (US); Prathamesh Sankhe, Seattle, WA (US); Cruz Philippe, Seattle, WA (US)

(21) Appl. No.: 18/540,784

(22) Filed: Dec. 14, 2023

(51) Int. Cl. A23J 3/22; B01F 23/50; B01F 23/53; B01F 27/112; B01F 27/70; B01F 101/06

(52) U.S. Cl. CPC A23J 3/227; B01F 23/53; B01F 23/54; B01F 27/112; B01F 27/70; B01F 2101/06

(57) ABSTRACT

An apparatus configured to process foodstuff materials can include a material passage, inner shaft, input region(s), and multiple protrusions extending from the shaft. The material passage can have an inlet, outlet, bottom, sidewall(s), and a longitudinal axis, and can facilitate conveyance of foodstuff materials. The inner shaft can be rotationally driven within the material passage along the longitudinal axis. The input region(s) can facilitate adding water to the foodstuff materials within the material passage to facilitate hydration thereof. The multiple protrusions can extend from and rotate with the inner shaft. Each protrusion can include a post coupled to the inner shaft and a plowhead coupled to the post. Each plowhead can include a driving surface, at least some of which are arranged at an angle with respect to the longitudinal axis such that those driving surfaces push the foodstuff materials toward the outlet when the inner shaft is rotationally driven.

### TECHNICAL FIELD

The present disclosure relates generally to food processing, and more particularly to systems and methods that can be used in the production of meat analogue products.

### BACKGROUND

Plant-based meat analogue products (“plant-based meat”) are becoming increasingly popular and plant-based meat production is a rapidly growing industry. Some aspects of plant-based meat production include hydrating, mixing, and agitating various ingredients or foodstuff materials during processing. Such foodstuff materials for plant-based meat production can include, for example, texturized vegetable protein, hydrated vegetable protein, methylcellulose, oil, and water, among other possible foodstuff materials. Traditional ways of hydrating, mixing, agitating, conveying, and otherwise processing plant-based foodstuff materials include batch processes using bowl choppers, blenders, globe mixers, or the like, due to the generally difficult nature of many of these foodstuff materials. The difficult nature of these materials can result in processing issues that can include the adequate hydration and mixing of these materials, as well as the processed materials being highly viscous and clumping together when wet.

Recent advancements in plant-based meat production include systems and processes that are more continuous rather than batch process based. Some of these are disclosed in, for example, U.S. Pat. No. 11,606,959 to Lagally et al., which is incorporated by reference in its entirety herein. These systems and processes can include continuously operating conveyance mechanisms, emulsifiers, hydrators, and mixers, for example, which can combine to significantly reduce the amount of manual labor and product inconsistencies that can occur in traditional batch processing of plant-based meat foodstuffs, materials, and products.

Unfortunately, even more recent plant-based meat processing systems can experience issues with the difficult nature of these materials. Again, these materials can be highly viscous and tend to be sticky and clump together when wet, resulting in clumping, lumping, and even clogging of automated processing components. This can result in undesirable amounts of manual intervention in some automated processes to facilitate the continuous ongoing processing of consistent end materials. Problems experienced in recently developed continuously operating processing systems and methods can include, for example, processed materials clumping and sticking to various system components, system clogs that can result in reduced outputs and system overflows, undesirable inconsistencies in mixed output materials, and limited scalability and flexibility in system components and overall systems, among other issues.

Although traditional ways of processing plant-based meat products have functioned in the past, improvements are always welcome. In particular, what is desired are improved systems and methods for the automated processing of foodstuff materials that result in requiring less manual intervention and more continuous and consistent outputs.

### SUMMARY

It is an advantage of the present disclosure to provide improved systems and methods for the automated processing of foodstuff materials that require little to no manual intervention and that result in more continuous and consistent outputs of processed materials. The disclosed features, apparatuses, systems, and methods relate to foodstuff processing apparatuses and systems that can operate to continuously hydrate, agitate, mix, and/or convey foodstuff materials in an improved and more reliable manner. This can include hydration systems with adjustable agitation features, for example, and can involve using components that are scalable and flexible, such that the components and overall system can be scaled or adjusted to support variable output levels and multiple varieties of ingredients that can have variable hydration ratios and times.

In various embodiments of the present disclosure, an apparatus configured to process foodstuff materials can include a material passage, an inner shaft, and multiple protrusions on the inner shaft. The material passage can have an inlet, an outlet, a bottom, one or more sidewalls, and can define a longitudinal axis therethrough. The material passage can be configured to facilitate the conveyance of foodstuff materials from the inlet to the outlet. The inner shaft can be located within the material passage, can extend along the longitudinal axis between the inlet and the outlet, and can be configured to be rotationally driven. The multiple protrusions can extend from the inner shaft and can be configured to rotate with the inner shaft when the inner shaft is rotationally driven. Each of the multiple protrusions can include a post coupled to the inner shaft and a plowhead coupled to a distal end of the post away from the inner shaft. Each of at least a first portion of the plowheads can include a driving surface arranged at an acute angle with respect to the longitudinal axis such that the driving surface forces the foodstuff materials toward the outlet when the inner shaft is rotationally driven.

In various detailed embodiments, the outlet can be located along the bottom proximate an outlet end of the material passage. In some arrangements, the material passage can be a hollow tube, and in some arrangements the material passage can be a U-shaped trough. One or more passive mechanical inserts can extend from the sidewall(s) of the U-shaped trough when used, and such passive mechanical inserts can prevent or minimize buildup of the foodstuff materials on the sidewall(s). In some arrangements, the material passage, the inner shaft, and the multiple protrusions can all be interchangeable with similar components to facilitate scalability of the apparatus for different foodstuff materials, variable outputs, or other production parameters. At least a portion of the posts can each be removably coupled to the inner shaft, at least a portion of the plowheads can each be removably coupled to their respective posts, or both. The inner shaft and multiple protrusions coupled thereto can be configured to be removed from the material passage as a combined unit and replaced with an alternative combined unit of inner shaft and multiple protrusions. In addition, the apparatus can include one or more input regions configured for adding water to the foodstuff materials within the material passage. As such, the apparatus can be further configured to facilitate hydration of the foodstuff material during conveyance of the foodstuff materials from the inlet to the outlet.

In various further detailed embodiments, each of the first portion of plowheads can further include a first pointed corner at a first edge of its driving surface. This first pointed corner can point toward a sidewall of the material passage and can be configured to cut into the foodstuff materials as the plowhead is rotationally driven therethrough. Each of the first portion of plowheads can further include a second pointed corner at a second edge of its driving surface opposite the first edge. This second pointed corner can point toward the outlet of the material passage. In some arrangements, each of the plowheads can define a triangular wedge shape having a top surface that faces a sidewall of the material passage, a bottom surface that faces the inner shaft, and three side surfaces between the top surface and bottom surface, with the driving surface being one of the three side surfaces. The top surface of each plowhead can define a curved surface that moves along the bottom and one or more sidewalls of the material passage at a minimal clearance therefrom as the plowheads rotate with the inner shaft. The minimal clearance between the top surfaces of the plowheads and the bottom and one or more sidewalls of the material passage can be about 3 mm.

In various further embodiments of the present disclosure, various methods of processing foodstuff materials are provided. Pertinent process steps can include providing foodstuff materials into a material passage, rotating an inner shaft within the material passage, conveying the foodstuff materials through the material passage, and collecting the foodstuff materials from an outlet of the material passage. The material passage can have at least a bottom, one or more sidewalls, and an outlet, and the material passage can define a longitudinal axis therethrough. The inner shaft can be rotated about the longitudinal axis, and the inner shaft can have multiple protrusions extending therefrom that rotate with the inner shaft. Each of the multiple protrusions can include a post coupled to the inner shaft and a plowhead coupled to a distal end of the post away from the inner shaft. Each of the plowheads can have a driving surface arranged at an acute angle with respect to the longitudinal axis. Conveying the foodstuff materials can be at least partially facilitated by the driving surfaces of the plowheads pushing the foodstuff materials toward the outlet when the inner shaft and multiple protrusions are rotated about the longitudinal axis.

In various detailed embodiments, each of the steps of providing, rotating, conveying, and collecting can be performed automatically by an automated system. Further process steps can include one or more of agitating the foodstuff materials, providing water into the material passage, preventing buildup of the foodstuff materials, removing the inner shaft, and installing a replacement inner shaft. Agitating foodstuff materials within the material passage can at least be partially facilitated by the plowheads when the inner shaft and multiple protrusions are rotated about the longitudinal axis. Providing water into the material passage while the foodstuff materials are within the material passage can produce a plurality of hydrated foodstuff material particles. Preventing buildup can minimize or eliminate foodstuff material buildup along one or more sidewalls as the foodstuff materials are conveyed through the material passage, particularly for material passages that are U-shaped troughs. Removing the inner shaft and multiple protrusions coupled thereto from the material passage and installing a replacement inner shaft having replacement protrusions coupled thereto into the material passage can facilitate greater scalability and flexibility for the apparatus. As such, the replacement protrusions can be arranged differently than the removed multiple protrusions on the removed inner shaft.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures, arrangements, and methods of use for foodstuff processing apparatuses and systems, such as hydration systems having adjustable agitation features. These drawings in no way limit any changes in form and detail that may be made to the disclosure by one skilled in the art without departing from the spirit and scope of the disclosure.

FIG. 1 illustrates in side elevation view an example foodstuff conveyance device configured for the continuous processing and conveying of foodstuff materials.

FIG. 2 illustrates in top perspective view an example foodstuff processing apparatus according to one embodiment of the present disclosure.

FIG. 3 illustrates a flowchart of an example summary method of processing foodstuff materials according to one embodiment of the present disclosure.

FIG. 4A illustrates in top and side perspective view an example foodstuff processing apparatus from a front end according to one embodiment of the present disclosure.

FIG. 4B illustrates in top perspective partially exploded view an example foodstuff processing apparatus according to one embodiment of the present disclosure.

FIG. 5A illustrates in top perspective view an example plowhead for a foodstuff processing apparatus according to one embodiment of the present disclosure.

FIG. 5B illustrates in bottom plan view the plowhead of FIG. 5A according to one embodiment of the present disclosure.

FIG. 5C illustrates in rear elevation view the plowhead of FIG. 5A according to one embodiment of the present disclosure.

FIG. 5D illustrates in side elevation view the plowhead of FIG. 5A according to one embodiment of the present disclosure.

FIG. 6A illustrates in front end cross-section view an example foodstuff processing apparatus having a sidewall insert according to one embodiment of the present disclosure.

FIG. 6B illustrates in front end cross-section view an example foodstuff processing apparatus having an alternative sidewall insert according to one embodiment of the present disclosure.

FIG. 7A illustrates in side elevation view an example foodstuff processing system including the foodstuff processing apparatus of FIG. 2 according to one embodiment of the present disclosure.

FIG. 7B illustrates in front elevation view the foodstuff processing system of FIG. 7A according to one embodiment of the present disclosure.

FIG. 8 illustrates a flowchart of an example detailed method of processing foodstuff materials using a foodstuff processing apparatus having plowheads with driving surfaces according to one embodiment of the present disclosure.

FIG. 9 illustrates in top plan view an example alternative foodstuff processing apparatus according to one embodiment of the present disclosure.

FIG. 10A illustrates in top perspective view an example alternative plowhead for a foodstuff processing apparatus according to one embodiment of the present disclosure.

FIG. 10B illustrates in front elevation view the alternative plowhead of FIG. 10A according to one embodiment of the present disclosure.

FIG. 10C illustrates in top plan view the alternative plowhead of FIG. 10A oriented with respect to a longitudinal axis according to one embodiment of the present disclosure.

FIG. 11 illustrates in top plan view an example alternative foodstuff processing system according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to features, apparatuses, systems, and methods for the automated and continuous processing of foodstuff materials, and in particular plant-based meat foodstuff materials. The disclosed embodiments include foodstuff processing apparatuses and systems that can operate to continuously hydrate, agitate, mix, and/or convey foodstuff materials in an improved and more reliable manner. This can include hydration systems with adjustable agitation features, for example, and can involve using components that are scalable and flexible, such that the components and overall system can be scaled or adjusted to support variable output levels and different sets of foodstuff materials that can have variable hydration ratios and times. Foodstuff materials can include, but are not limited to, texturized vegetable proteins, hydrated vegetable proteins, methylcellulose, oils, water, flavorings, and processing aids, among other possible materials.

Although various embodiments disclosed herein discuss hydration systems for processing plant-based meat foodstuff materials in particular, it will be readily appreciated that the disclosed features, apparatuses, systems, and methods can similarly be with other material processing systems and components, as well as any suitable substitute or alternative materials that take advantage of the disclosed features. Also, while specific illustrated examples are provided for the adjustable, variable, and scalable material passages, rotatable shafts, and multiple protrusions or other agitation features and protrusions disclosed herein, it will be understood that suitable alternative forms of material passages, rotatable shafts, multiple protrusions, and agitation features can also be implemented. Other applications, arrangements, and extrapolations beyond the illustrated embodiments are also contemplated.

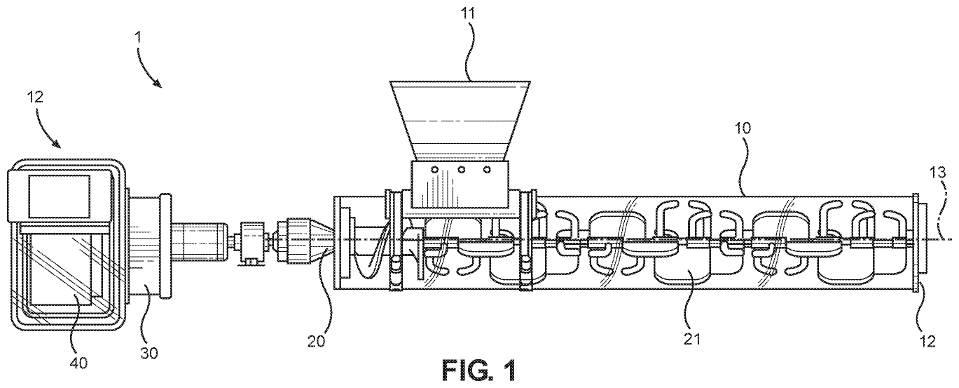

Referring first to FIG. 1, an example foodstuff conveyance device configured for the continuous processing and conveying of foodstuff materials is shown in side elevation view. Foodstuff conveyance device 1 can be an apparatus or overall system configured to continuously hydrate, agitate, mix, convey, and/or otherwise process foodstuff materials, such as plant-based meat analogue foodstuff materials. Various different foodstuff materials can be used with foodstuff conveyance device 1, and such foodstuff materials can be in the form of small pieces, flakes, powders, and/or liquids, among other possible foodstuff materials. In one specific non-limiting example for purposes of illustration, the foodstuff materials can include texturized vegetable protein and water, which can be hydrated, agitated, mixed together, and conveyed in foodstuff conveyance device 1 to form hydrated vegetable protein. Of course, other foodstuff materials can also be used as may be desired.

In general, foodstuff conveyance device 1 can include a hollow tube 10, a central or inner shaft 20 having a plurality of agitation components 21 coupled thereto, a rotational motor 30, and a controller 40, among other possible components. Hollow tube 10 can have an inlet 11 and outlet 12, can define a longitudinal central axis 13 running therethrough, and can be configured to facilitate the conveyance of foodstuff materials from its inlet to its outlet. Inlet 11 can be in the form of a hopper, funnel, chute, or other suitable delivery component configured to intake the foodstuff materials, which can include texturized vegetable protein and water, for example. Central shaft 20 can extend along longitudinal axis 13 and can be configured to be rotationally driven in clockwise and/or counterclockwise directions by rotational motor 30. Agitation components 21, such as paddles, hooks, loops, and the like, as shown, can be coupled to the central or inner shaft 20 and can be configured to rotate with the shaft to agitate and mix the foodstuff materials being conveyed along hollow tube 10 from inlet 11 toward outlet 12. One or more hydration ports or inlets (not shown) can be distributed across hollow tube 10 to facilitate the input of water into the hollow tube.

Controller 40 can include a processor configured to control the rotational direction and speed of motor 30 and can also include a user interface such as a touchscreen, keypad, buttons, or the like. One or more programs can be configured using the controller to control electronically and automatically the rotation of central or inner shaft 20. In some arrangements, the controller can rotate shaft 20 (and agitation components 21 correspondingly) clockwise for a first set speed and first time interval and then counterclockwise for a second set speed and second time interval. Alternatively, numbers of rotations may be used. For example, rotation can be set at a 4:3 ratio or interval, such that 4 clockwise rotations are made over a time period x, and then direction is reversed for 3 counterclockwise rotations over a time period y. This 4:3 oscillating rotations process can then be repeated indefinitely so long as continuous processing or production is desired. Other ratios or intervals may also be used, such as 6:5, 1:1, 1:0, or any other number of rotations desired in either or both directions.

Further details regarding foodstuff conveyance device 1 and its various components are provided in commonly owned U.S. patent application Ser. No. 17/402,478 to Grubb, which is incorporated by reference in its entirety herein. Other foodstuff conveyance devices configured for the continuous processing of foodstuff materials can be found in, for example, U.S. Pat. No. 11,606,959 to Lagally et al. and U.S. Pat. No. 11,432,565 to Lagally et al., both of which are incorporated by reference in their entireties herein. It will be understood that one or more components or features of foodstuff conveyance device 1 can be used in place of or in addition to the various components and features of the foodstuff processing systems and apparatuses set forth in detail below, and that implementation or extrapolation of such components or features will be readily appreciated by those of skill in the art.

As noted above, various difficulties can arise when using a continuously operating foodstuff conveyance device or system to process foodstuff material for plant-based meat. These can include, for example, hydrated foodstuff materials lumping and clumping together, resulting in the materials sticking to conveyances, paddles, protrusions, and other system components, as well as causing frequent clogs within hollow tubes or other system conveyances or components. These issues can in turn result in system overflows and end food product safety risks for delays due to unclogging and increased processing times, as well as end food product inconsistencies in quality due to excessive and irregular material lumping and clumping that can affect consistent material hydration and processing. In addition, many early systems and system components are not scalable, have designs that result in minimal to no flexibility, and have some geometries that are complicated and difficult to manufacture in practice. For example, where a hollow tube or other material passage having a 24 inch diameter might be desired, this would typically require agitation paddles that are 4 inches by 24 inches, which can be impractical to manufacture. Early system design also resulted in a need or strong preference for frequent direction reversals and other changes in the rotational operation of the central or inner shaft, which then generates excessive wear on the motor, gearbox, and other associated components. These and other problems and issues can be eliminated or minimized through improvements in existing system components, as well as new features and components designed to overcome these drawbacks.

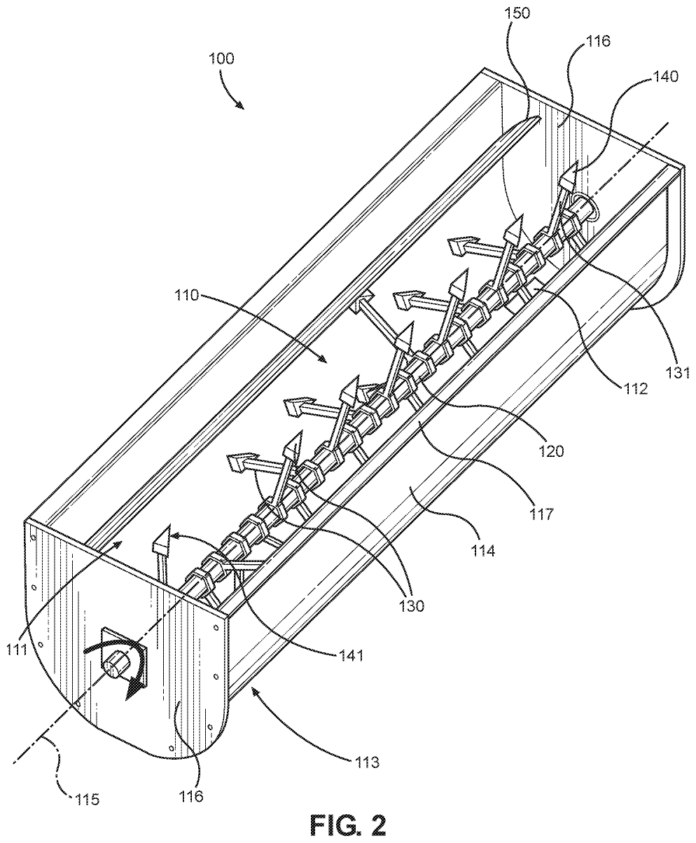

Turning next to FIG. 2, an example foodstuff processing apparatus according to one embodiment of the present disclosure is illustrated in top perspective view. Foodstuff processing apparatus 100 can also be an apparatus or part of an overall system configured to continuously hydrate, agitate, mix, convey, and/or otherwise process foodstuff materials, such as plant-based meat analogue foodstuff materials. Foodstuff processing apparatus 100 can include a material passage 110, an inner shaft 120, and multiple protrusions 130 extending from the inner shaft, among other possible components.

Material passage 110 can include at least one inlet 111 or inlet region configured to accept foodstuff materials, at least one outlet 112 configured to output processed foodstuff materials, a bottom 113, and one or more sidewalls 114, and can also define a longitudinal axis 115 extending therethrough. Material passage 110 can generally be configured to facilitate the conveyance of foodstuff materials from one or more inlets 111 to outlet 112. In some arrangements, material passage 110 can be a U-shaped trough, as shown. Endcaps 116 can be coupled to front and back ends of such a U-shaped trough to prevent the escape of foodstuff materials. Alternatively, the material passage can be a hollow tube (not shown), similar to hollow tube 10 above. Other forms and shapes of material passages are also possible.

Inlet 111 can be located at the top and proximate a front end of material passage 110, while outlet 112 can be located through bottom 113 and proximate an opposite back end of the material passage such that material flows out of the material passage vertically. Alternatively, the outlet can be located through endcap 116 at the back end of the material passage such that material flows out of the material passage horizontally. Although only one inlet 111 and only one outlet 112 are shown for purposes of illustration, it will be readily appreciated that multiple inlets and/or multiple outlets can be used, and that these items can be placed at other locations on material passage 110. In some arrangements, the open top of a U-shaped trough used to form material passage 110 can be covered by one or more removable plates or panels (not shown), and such removable plates or panels can include one or more openings therethrough or therebetween that can serve as one or more inlets for foodstuff materials.

In some arrangements, the U-shaped trough can be integrally formed by way of a continuous piece of sheet metal arranged to form a bottom 113, two sidewalls 114 extending vertically upward therefrom on both sides, and flanges 117 extending outward horizontally from upper edges of both the two sidewalls. Where a U-shaped trough forms material passage 110, one or more inserts 150 extending from at least one sidewall 114 of the U-shaped trough can be used to minimize buildup of foodstuff materials on the sidewall(s). As shown in FIG. 2, a single insert 150 is located on one sidewall and extends the full length of material passage 110 from one endcap 116 to the other. Other types and arrangements of inserts 150 are possible, and some or all of the one or more inserts can be passive mechanical inserts in some embodiments, examples for which are detailed below.

Inner shaft 120 can be located within material passage 110 and can be aligned with and/or extend along longitudinal axis 115 between inlet 111 and outlet 112. Similar to the shaft in foodstuff conveyance device 1 above, inner shaft 120 can be configured to be rotationally driven, such as by a rotational motor (not shown) and controller (not shown) that can be located outside of material passage 110. For example, a portion of inner shaft 120 can extend through endcap 116 at the front end of material passage 110, and a rotational motor can be coupled to and drive this extending portion of the inner shaft. For purposes of stability, inner shaft 120 can also extend into or through endcap 116 at the back end of material passage 110 as well. One or more gaskets, bearings, bearing blocks, and/or other components can be used to facilitate such an arrangement, as set forth in greater detail below.

Multiple protrusions 130 can extend from inner shaft 120 and can be configured to rotate with the inner shaft when the inner shaft is rotationally driven. Some or all of multiple protrusions 130 can include a post 131 coupled to the inner shaft and a plowhead 140 or other paddle type feature coupled to a distal end of the post away from the inner shaft, as shown. Some or all of plowheads 140 can include a driving surface 141 configured to push foodstuff materials when inner shaft 120 is rotationally driven. At least a first portion of the driving surfaces 141 can be arranged at an acute angle with respect to longitudinal axis 115 such that these driving surface push or force foodstuff materials toward outlet 112 when inner shaft 120 is rotationally driven in an appropriate direction, such as the rotational direction shown in FIG. 2. Each plowhead 140 can be considered an agitation component. Other functions and features of inner shaft 120, protrusions 130, plowheads 140, and inserts 150 are provided in detail below.

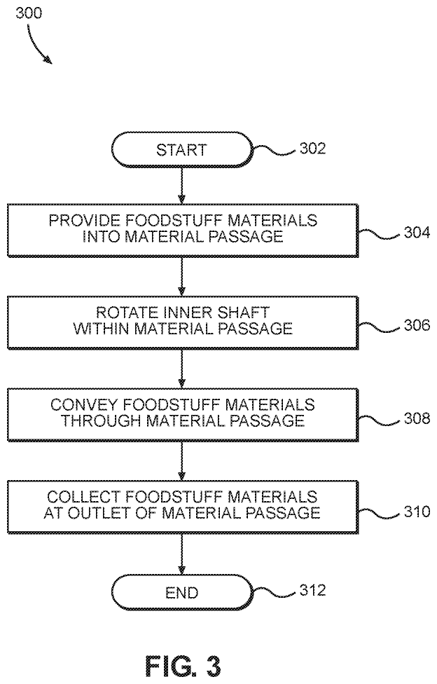

Continuing with FIG. 3, a flowchart of an example summary method of processing foodstuff materials is provided. It will be readily appreciated that summary method 300 can be a high level method such that one or more steps can be omitted, various other steps can be added, and/or the order of steps can be altered as may be desired. Summary method 300 can relate primarily to the continuous processing of foodstuff materials using one or more of the various foodstuff processing features, apparatuses, and systems disclosed herein, although other aspects of processing foodstuff materials can also be included in some arrangements.

After a start step 302, a first process step 304 can involve providing foodstuff materials into a material passage. This can involve a material passage having at least a bottom, one or more sidewalls, and an outlet, with the material passage defining a longitudinal axis therethrough. As noted above, the material passage can form a U-shaped trough or a hollow tube, for example, although other material passage forms are also possible. Foodstuff materials can include, but are not limited to, texturized vegetable proteins, hydrated vegetable proteins, methylcellulose, oils, water, flavorings, and processing aids, among other possible materials. Step 304 can be performed automatically, such as by an automated system configured to feed the foodstuff materials in dosed amounts through one or more inlets of the material passage.

At the next process step 306, an inner shaft can be rotated within the material passage about a longitudinal axis extending through the material passage. This can be done using a rotational motor coupled to and configured to rotate the inner shaft. The inner shaft can have multiple protrusions extending therefrom that rotate with the inner shaft, and each of the multiple protrusions can include a post coupled to the inner shaft and a plowhead coupled to a distal end of the post away from the inner shaft, with at least a portion of the plowheads having a driving surface arranged at an acute angle with respect to the longitudinal axis, as noted above. Step 306 can be performed automatically, such as by a controller having one or more processors that is configured to control and drive a rotational motor coupled to the inner shaft.

At a following process step 308, the foodstuff materials can be conveyed through the material passage toward its outlet. Such conveying can be at least partially facilitated by the driving surfaces of the plowheads pushing or forcing the foodstuff materials toward the outlet when the inner shaft and multiple protrusions are rotated about the longitudinal axis. Conveying can be performed on dry foodstuff materials, hydrated foodstuff materials, or both. Step 308 can be performed automatically, such as by way of the natural results of a system design where the driving surfaces face in a particular direction and the plowheads rotate with the inner shaft when the inner shaft is automatically rotated by way of a rotational motor and controller.

Subsequent process step 310 can involve collecting the foodstuff materials from the outlet of the material passage. In some arrangements, the outlet can be located through the bottom of the material passage proximate a back end of the material passage, although other locations are possible. Step 310 can be performed automatically, such as by using one or more additional automated conveyances and/or components of an overall system that are situated outside the outlet. The method can then end at end step 312.

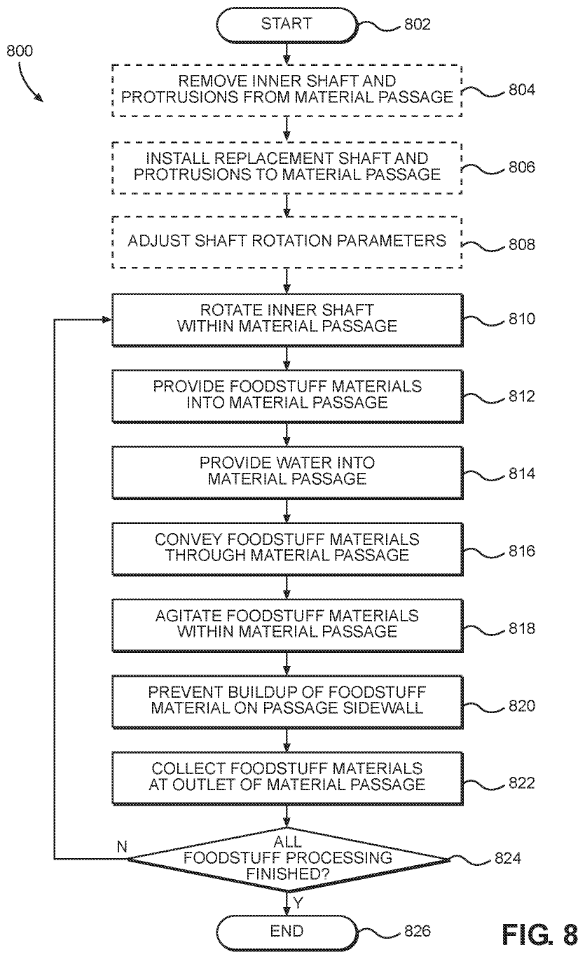

Again, method 300 can vary in some ways. For example, additional process steps can include inputting water into the material passage to produce a plurality of hydrated foodstuff material particles and agitating the foodstuff materials while the foodstuff materials are within the material passage. Process steps regarding altering the rotation of the inner shaft can also be included, as well as steps regarding removal of the inner shaft and protrusions and replacement with an alternative inner shaft and protrusions. Also, some steps can be performed in a different order and some steps can be performed simultaneously. For example, all of steps 304-310 can be performed simultaneously during continuous and ongoing foodstuff material processing. Some or all of steps 304-310 for providing, rotating, conveying, and collecting can be performed automatically by an automated system. Further possible process steps and detailed descriptions are provided below with respect to the detailed method 800 set forth in FIG. 8.

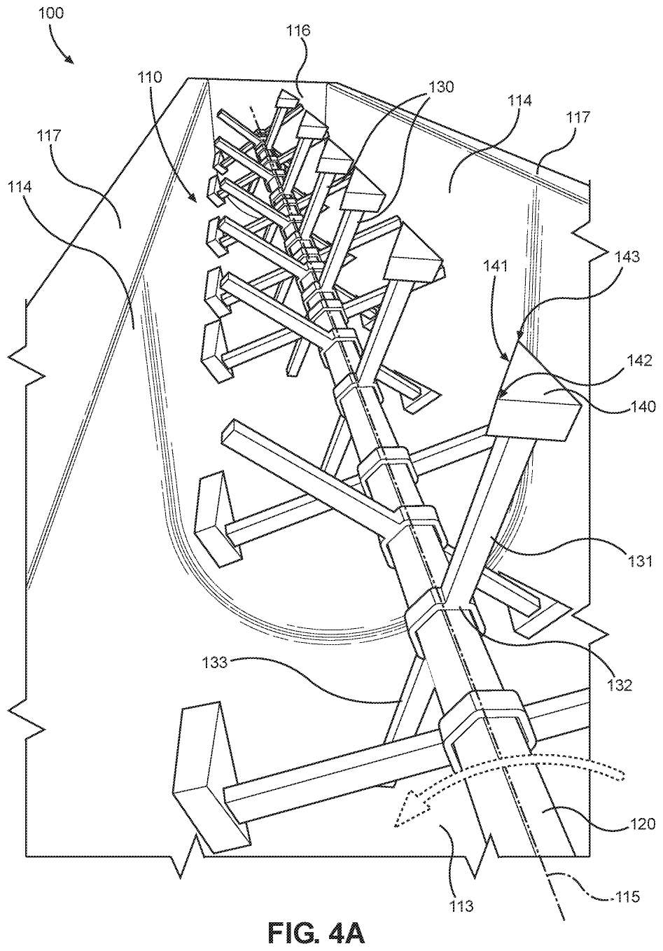

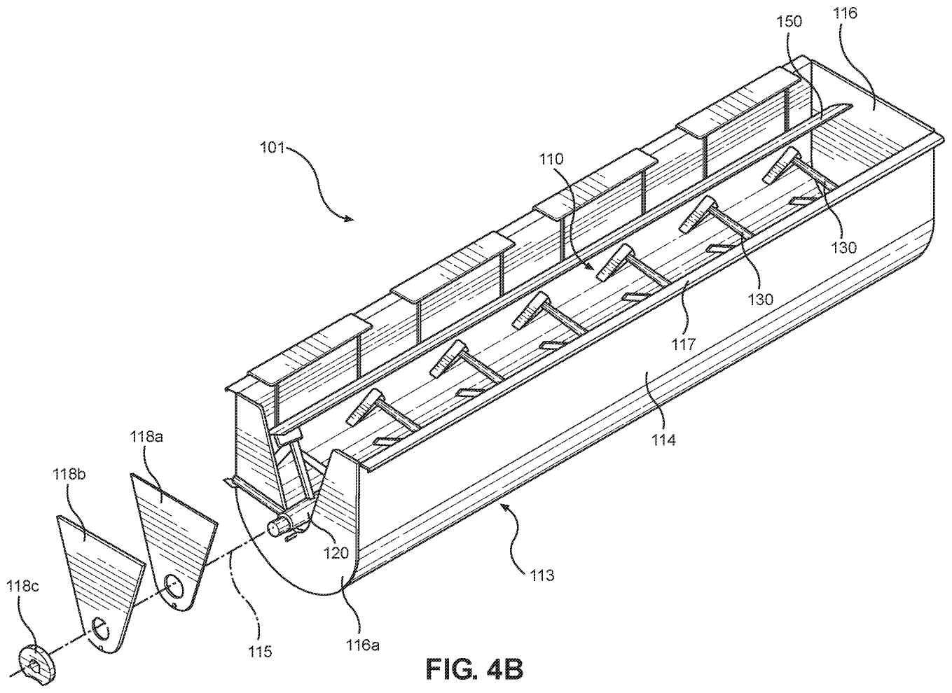

Moving next to FIG. 4A, an example foodstuff processing apparatus is shown in top and side perspective view from its front end. Foodstuff processing apparatus 100 can be identical or substantially similar to the apparatus described and illustrated above in FIG. 2, as minor details may vary. For example, insert 150 has been omitted for purposes of illustration. Again, foodstuff processing apparatus 100 can include a material passage 110, an inner shaft 120, and multiple protrusions 130 extending from the inner shaft, all of which can combine to continuously hydrate, agitate, mix, convey, and/or otherwise process foodstuff materials, such as plant-based meat analogue foodstuff materials. Material passage 110 can form a U-shaped trough that can include a bottom 113, sidewalls 114, a longitudinal axis 115, and endcaps 116, among other items including those noted above. Inner shaft 120 can be within material passage 110, can extend along the longitudinal axis 115, and can be rotationally driven about this axis. Multiple protrusions 130 can extend from inner shaft 120 and can rotate with the inner shaft when the inner shaft is rotationally driven. Some or all of multiple protrusions 130 can include a post 131 coupled to inner shaft 120 and a plowhead 140 or other paddle type feature coupled to a distal end of the post away from the inner shaft.

In some embodiments, the combined surface areas of inner shaft 120, multiple protrusions 130, and the various features thereof can be minimized so as to reduce the amount of clumping, sticking, and clogging of foodstuff materials to these moving components during material processing through material passage 110. As such, the diameter and overall profile of inner shaft 120 can be as small as possible while still allowing the shaft to be strong enough to bear expected loads thereupon. The diameters and overall profiles of each post 131 can similarly be as small as possible, and the size, shape, and profile of each plowhead 140 can be as small as possible beyond those surfaces and features that are desirable for processing foodstuff materials.

Multiple protrusions 130 can serve as agitation features during operation of foodstuff processing apparatus 100, and such agitation features can be variable or adjustable in arrangement, orientation, and interchangeability. Posts 131 can be permanently or removably coupled to inner shaft 120 in any suitable manner, such as by welds, glue, rivets, bolts, screws, brackets, sleeves, press-fits, or the like. One or more posts 131 can also be integrally formed with inner shaft 120 in some cases. In some embodiments, such as that shown in FIG. 4A, each post 131 can be coupled to or integrally formed with a collar 132 that wraps around inner shaft 120. Collar 132 and inner shaft 120 can have a matching cross-sectional shape, such as hexagonal, for example, such that the collar can be slid onto the inner shaft and does not swivel or rotate around the shaft but rather rotates with the shaft during shaft rotational movement. Collar 132 can be affixed to inner shaft 120 in some cases or can be configured to slide up and down the shaft to different lateral positions to allow variability in arrangements of protrusions 130, which can include posts 131 and plowheads 140. A locking mechanism (not shown) such as a spring-loaded pin, bracket, latch, physical hard stop, weld joint, or the like, can be used to hold collar 132 in place at a given location along inner shaft 120 such that the collar and the rest of its associated protrusion 130 does not slide along the shaft during foodstuff material processing within material passage 110.

In some arrangements a protrusion 130 can have a single post 131 that extends from inner shaft 120, while other arrangements can include multiple posts that extend from the inner shaft. For example, some or all protrusions 130 can have two posts 131, 133 that extend from opposite sides of an associated collar 132 and inner shaft 120 in opposite directions, as shown in FIG. 4A. Plowheads 140 can be coupled to the distal end of one or both posts 131, 133 for some or all of protrusions 130. Each plowhead 140 can be permanently or removably coupled to its respective post 131 in any suitable manner, such as by welds, glue, rivets, bolts, screws, brackets, sleeves, press-fits, or the like. For example, a plowhead 140 can have an internal cavity with an opening at a bottom surface of the plowhead that can be configured to accept a post 131 therein. One end of a post 131 can be inserted into the opening and internal cavity and can be welded, glued, press-fit or otherwise permanently or removably coupled to the plowhead internal cavity.

Some or all of plowheads 140 can include a driving surface 141 arranged at an acute angle with respect to longitudinal axis 115 of material passage 110 such that the driving surface pushes or forces foodstuff materials toward a back end and outlet of the material passage when the inner shaft 120 is rotationally driven in an appropriate direction. For example, when inner shaft 120 rotates in the direction shown in FIG. 4A, then protrusions 130 rotate with the inner shaft in this direction and each driving surface 141 pushes any foodstuff materials that it contacts in a direction that is normal to the face of the driving surface. As will be readily appreciated, this normal direction can have a component that is perpendicular to the longitudinal axis and a component that is parallel with the longitudinal axis in a direction that is toward the back end of material passage 110 at endcap 116. In some embodiments, the acute angle between driving surface 141 and the longitudinal axis can be about 30 degrees, although other orientations and arrangement angles are also possible.

Some or all of plowheads 140 can also include a first pointed corner 142 located at a first edge of its respective driving surface 141. This first pointed corner 142 can be arranged to point toward a sidewall 114 of material passage 110 as shown, such that the first pointed corner can lead the rest of its plowhead 140 in rotational movement. As such, the first pointed corner 142 can be configured to plow or cut into foodstuff materials as its plowhead 140 is rotationally driven therethrough. In some embodiments, first pointed corner 142 can form an angle of about 60 degrees between driving surface 141 and an adjacent rear side of plowhead 140, although other angles are also possible. Some or all of plowheads 140 can also include a second pointed corner 143 at a second edge of its respective driving surface 141 opposite the first edge. This second pointed corner 143 can be arranged to point toward the back end and outlet of material passage 110 as shown. In some embodiments, second pointed corner 143 can form an angle of about 30 degrees between driving surface 141 and an adjacent lateral side of plowhead 140, although other angles are also possible.

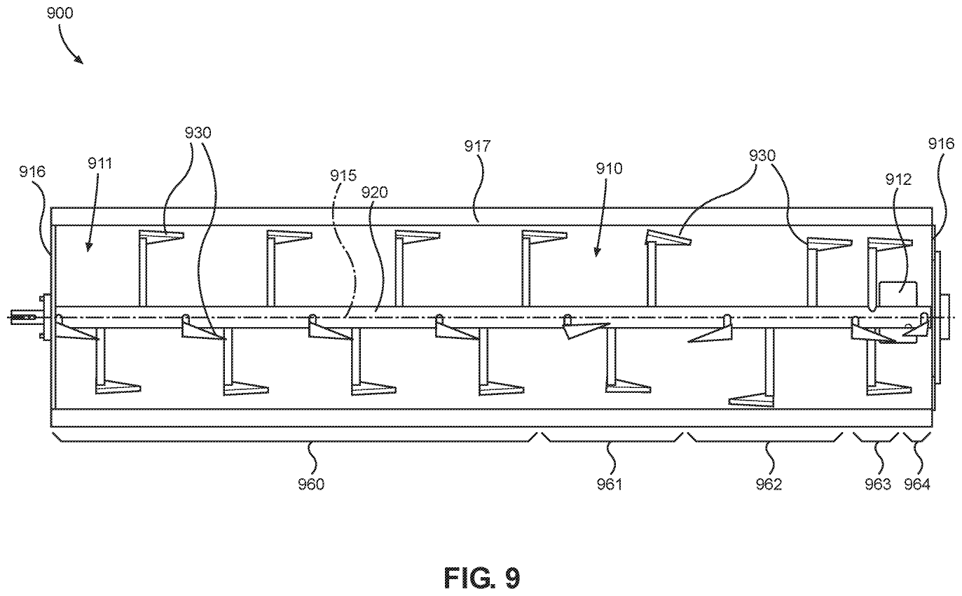

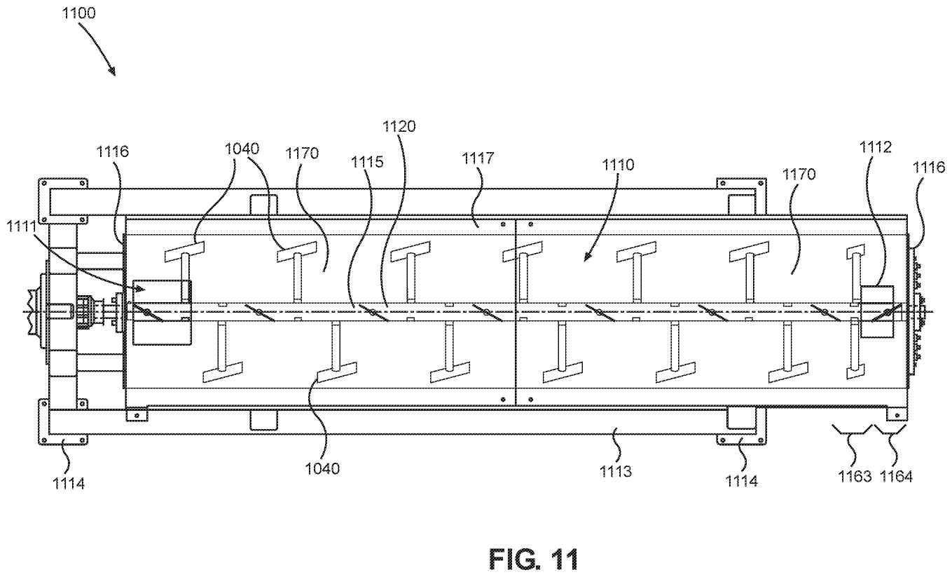

Although all plowheads 140 in FIGS. 2 and 4A are illustrated as being oriented in the same direction with their driving surfaces 141 arranged at the same acute angle with respect to longitudinal axis 115, it will be readily appreciated that various arrangements can include at least some plowheads that are oriented differently than others. For example, some of plowheads 140 can be oriented such that their driving surfaces 141 face and push foodstuff materials toward a sidewall 114 of material passage 110, while other plowheads can be oriented such that their driving surfaces are angled backwards and push foodstuff materials away from the back end and outlet of the material passage. Some examples of such arrangements are illustrated in FIGS. 9 and 11 and described in detail below.

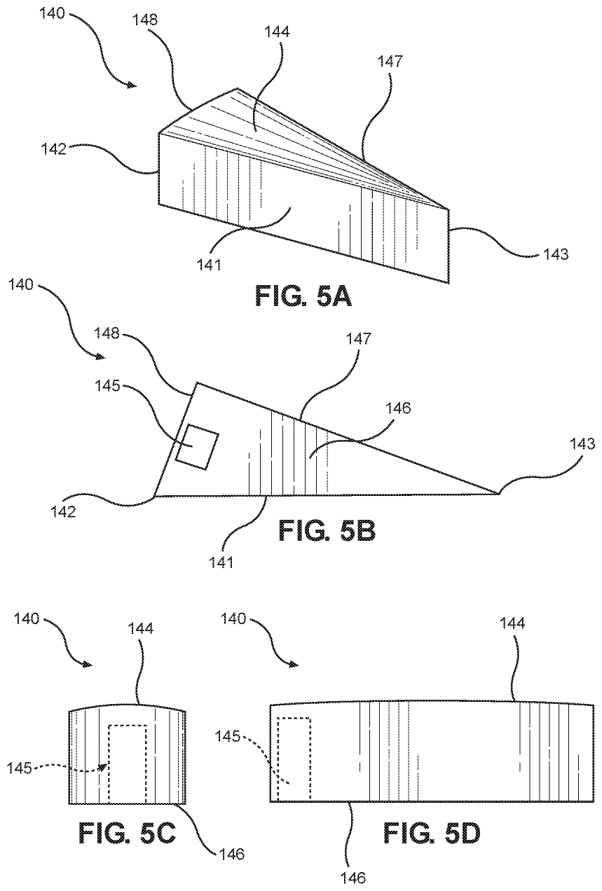

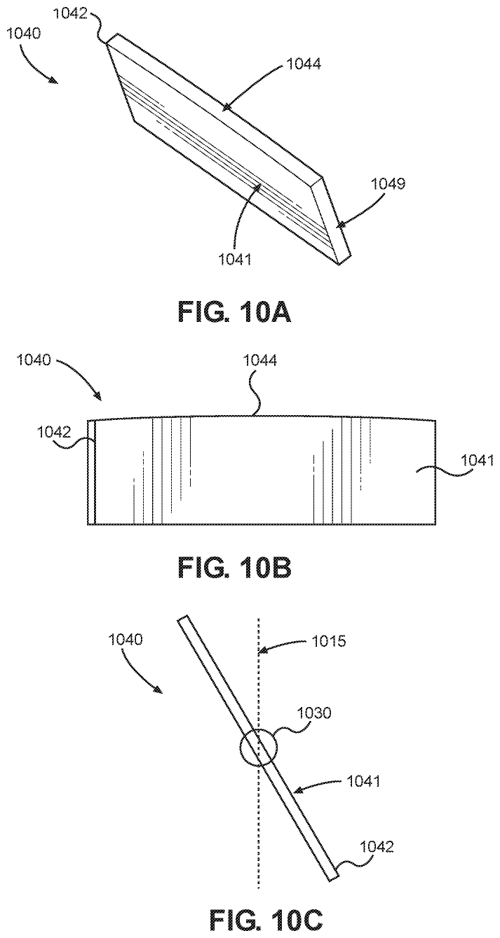

Because it can be desirable to minimize the size and surface area of plowhead 140, as noted above, some or all of plowheads 140 can each define a triangular wedge shape, which is illustrated and further detailed in FIGS. 5A-5D below. As such, each plowhead 140 can include a top surface that periodically directly faces a sidewall 114 of material passage 110 during rotational movement, a bottom surface that faces inner shaft 120, and three side surfaces between the top surface and bottom surface, with driving surface 141 being one of these three side surfaces. Other shapes for plowheads 140 are also possible, such as a flat paddle shape illustrated in FIGS. 10A through 11 and described in detail below.

In some embodiments, the top surface of each plowhead 140 can define a curved surface that moves along and proximate bottom 113 and sidewall(s) 114 of material passage 110 at a minimal clearance therefrom as the plowheads rotate with inner shaft 120. As will be readily appreciated, the clearance distance between moving plowheads 140 and the bottom and sidewalls of material passage 110 can be minimized as much as possible in order to eliminate or reduce the amount of processed foodstuff materials that can stagnate at the bottom of the material passage or elsewhere during processing. The curvature of the plowhead top surface can match the curvature of the bottom 113 and sidewall(s) 114 of material passage 110, such that the clearance between the plowhead 140 and bottom and sidewalls can remain relatively constant across the entire top surface and during motion thereof. This minimal clearance can be about 3 mm in some arrangements, although other distances are also possible.

In various embodiments, the material passage, the inner shaft, and/or the multiple protrusions can be readily interchangeable with similar components to facilitate scalability of the apparatus for different foodstuff materials, variable outputs, or other production parameters. FIG. 4B illustrates in top perspective partially exploded view an example foodstuff processing apparatus configured for such ready interchangeability. Foodstuff processing apparatus 101 can be identical or substantially similar to apparatus 100 shown in FIGS. 2 and 4A above, in that it can include a material passage 110, an inner shaft 120 configured to rotate about longitudinal axis 115, and multiple protrusions 130 extending from and rotating with the inner shaft. Again, material passage 110 can be a U-shaped trough having bottom 113, sidewalls 114, and flanges 117, as well as one or more inlets (not shown) located at or toward its front end at endcap 116, one or more outlets (not shown) located at or toward its back end at rear endcap 116a, and passive mechanical insert 150, among other possible components and features.

Unlike previous figures, foodstuff processing apparatus 101 is shown in FIG. 4B from rear to front for purposes of illustration in detailing example components that can be associated with rear endcap 116a. As will be readily appreciated, the front end of foodstuff processing apparatus 101 can be substantially similar to that which is shown in FIG. 2, where inner shaft 120 protrudes through front endcap 116 and can be coupled to an associated rotational motor at the front end. Such a coupled arrangement can be inconvenient for purposes of ready and easy partial disassembly so as to remove the inner shaft and its coupled protrusions from the material passage and overall apparatus. Accordingly, rear endcap 116a can be adapted for such purposes.

Rear endcap 116a can have a V-shaped opening therein that is configured to facilitate the ready removal of inner shaft 120 and protrusions 130 coupled thereto, which items can be removed separately or as a combined unit. Gasket 118a, removable plate 118b, and bearing block 118c can all be sized and shaped to slide onto and off from inner shaft 120. These items can all be firmly fastened or coupled to rear endcap 116a to cover the V-shaped opening and prevent materials from leaking through the rear endcap when inner shaft 120 is installed and foodstuff processing apparatus 101 is operational. This can be accomplished by multiple threaded studs protruding from 116a and through openings in gasket 118a, removable plate 118b, and bearing block 118c, along with corresponding nuts removably tightened onto the studs on the opposite sides of these items, for example, although other removable fastening arrangements are also possible.

Using such a removable fastening arrangement gasket 118a, removable plate 118b, and bearing block 118c can all be removed from rear endcap 116a to allow inner shaft 120 to be pulled out from inside the front endcap 116. The then unsupported shaft 120 can be lifted up and fully removed from foodstuff processing apparatus 101 such that another inner shaft having a same or similar length or footprint can then be installed. Such a replacement shaft can have differently arranged and oriented replacement protrusions 130 coupled thereto and configured for different results and/or different materials when used within apparatus 101. Other suitable types of arrangements can be used to facilitate the ready removal and replacement of entire shafts and coupled protrusions as combined units, as will be readily appreciated.

As can also be seen in FIG. 4B, inner shaft 120 can have a first cross-sectional diameter for the portion of the shaft that is inside material passage 110 and a second smaller cross-sectional diameter for the portion of the shaft that protrudes from rear endcap 116a and through bearing block 118c. In fact, a similar arrangement can be made at the front end of apparatus 101 with a smaller cross-sectional diameter of inner shaft 120 protruding through a bearing block at front endcap 116 to be coupled to the associated rotational motor (not shown). Such arrangements can allow the larger cross-sectional portions of the inner shaft to butt up against the bearing blocks but not pass through them, which can allow for greater stability and control of the inner shaft during operation of apparatus 101. It will also be understood that while the larger cross-sectional region of inner shaft 120 is shown as being circular in FIG. 4B, the cross-sectional shape of the larger shaft region can vary as may be desired and can also be hexagonal such as that which is shown in FIGS. 2 and 4A, for example.

Continuing with FIGS. 5A-5D, an example plowhead for a foodstuff processing apparatus is illustrated in top perspective, bottom plan, rear elevation, and side elevation views respectively. Although the term plowhead has been used herein to refer to the component specifically depicted in FIGS. 5A-5D, it will be readily appreciated that other names may also be used, such as, for example, paddle, wedge, pusher, driver, and agitation feature or component, among other possible terms. Again, plowhead 140 can define a triangular wedge shape having a driving surface 141, first pointed corner 142, and second pointed corner 143, as well as a curved top surface 144 and internal cavity 145 at a bottom surface 146. Driving surface 141 can form one side of the triangular wedge that can be adjacent to the other two sides 147, 148, with all three sides extending from top surface 144 to bottom surface 146.

As noted above, driving surface 141 can push or force foodstuff materials in a direction having at least a directional component that is toward a back end and outlet of the material passage during material processing. This directional component can be due to the orientation of driving surface 141 and its angle of incidence when contacting and pushing the foodstuff materials. Driving surface 141, which can also be called an angled face or lead face, can generally push foodstuff materials along the bottom of the material passage and then scoop and lift materials from the bottom as its respective plowhead 140 rotates upward away from the bottom of the U-shaped trough or other material passage.

As also noted above, first pointed corner 142, which can also be called a declumping corner, can be arranged to lead its entire plowhead 140 into foodstuff materials being processed as the plowhead rotates around the inner shaft inside of the material passage. This declumping corner 142 can be particularly effective in pushing through foodstuff materials and breaking up foodstuff material clumps and lumps as its plowhead 140 moves across the bottom of the material passage during material processing. Internal cavity 145 can be used to accept a distal end of an associated post therein in order to couple the plowhead 140 to the post. Of course, other features and arrangements can be used to couple plowheads and posts.

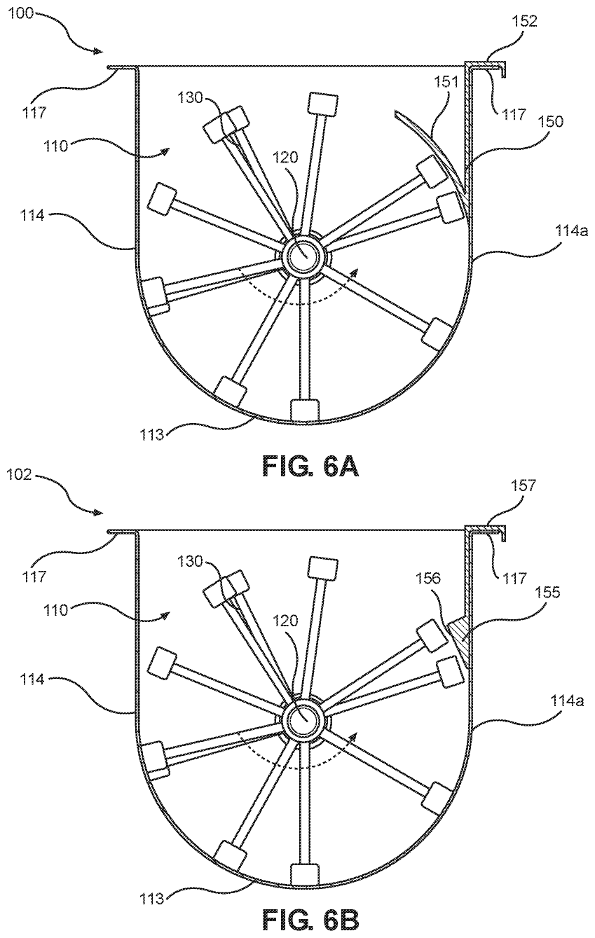

FIGS. 6A and 6B illustrate in front end cross-section views example foodstuff processing apparatuses having sidewall inserts, which can be passive mechanical inserts. Foodstuff processing apparatus 100 of FIG. 6A and foodstuff processing apparatus 102 of FIG. 6B can be identical or substantially similar to the apparatus shown in FIG. 2 above, with these apparatuses both including a material passage 110, an inner shaft 120, and multiple protrusions 130 extending from the inner shaft that rotate with the inner shaft in the direction shown. Both material passages 110 can be U-shaped troughs having bottoms 113, sidewalls 114, 114a, and flanges 117, such that each protrusion 130 can move downward along sidewall 114, then across bottom 113, and then upward along sidewall 114a in an ongoing and continuous rotational motion. As will be readily appreciated, this can result in some or all of protrusions 130 pushing foodstuff materials across bottom 113 and then scooping or lifting some foodstuff materials upward along sidewall 114a, such as by way of plowheads located at the distal ends of the protrusions.

Unfortunately, this upward motion of protrusions 130 and foodstuff materials along sidewall 114a can result in undesirable foodstuff material buildup along the sidewall, especially where the protrusions rotate to move away from the sidewall and thus increase the clearances therebetween. Accordingly, one or more passive mechanical inserts or other suitable items can extend from strategic locations along at least one sidewall of the U-shaped trough to minimize this buildup of foodstuff materials on the sidewall. Such inserts can include an extending surface or other suitable feature to maintain a tight clearance with the moving protrusions 130 at least until gravity can drop all or most of the foodstuff materials from the protrusions back toward the middle of the material passage, rather than allow these materials to build up where the protrusions begin to move away from the sidewall 114a.

As shown in FIG. 6A, insert 150 can be a passive mechanical insert that can include a curved surface 151 that extends away from sidewall 114a in a manner that can effectively extend the minimal clearance between the moving protrusions 130 and the sidewall to a similar minimal clearance between the moving protrusions and the insert curved surface. Insert 150 can be clipped to or otherwise hung from flange 117 located along the top edge of sidewall 114a, such as by way of a hanger or other clip feature 152 formed in or coupled to the insert. Insert 150 can extend along some or all of the length of sidewall 114a or alternatively can be broken up into multiple inserts that are installed at multiple strategic locations along the sidewall.

As shown in FIG. 6B, alternative insert 155 can similarly be a passive mechanical insert that can include a substantially linear extension surface 156 that extends away from sidewall 114a in a manner that can similarly effectively extend the minimal clearance between the moving protrusions 130 and the sidewall to a similar minimal clearance between the moving protrusions and the extension surface. Alternative insert 155 can similarly be clipped to or otherwise hung from flange 117 along the top edge of sidewall 114a, such as by way of a hanger or other clip feature 157 formed with or coupled to the insert. Insert 155 can also similarly extend along some or all of the length of sidewall 114a or alternatively can be broken up into multiple inserts that are installed at multiple strategic locations along the sidewall.

Although the term insert has been used for the purpose of illustration, it will be readily appreciated that alternative components or features can be arranged to provide the disclosed functionality of insert 150 or alternative insert 155. For example, insert 150 or alternative insert 155 can simply be a protrusion that is integrally formed with sidewall 114a rather than being a separate material or component. As another example, insert 150 or alternative insert 155 can be glued, welded, fastened, or otherwise coupled directly to sidewall 114a rather than hung by way of a hanger or clip feature.

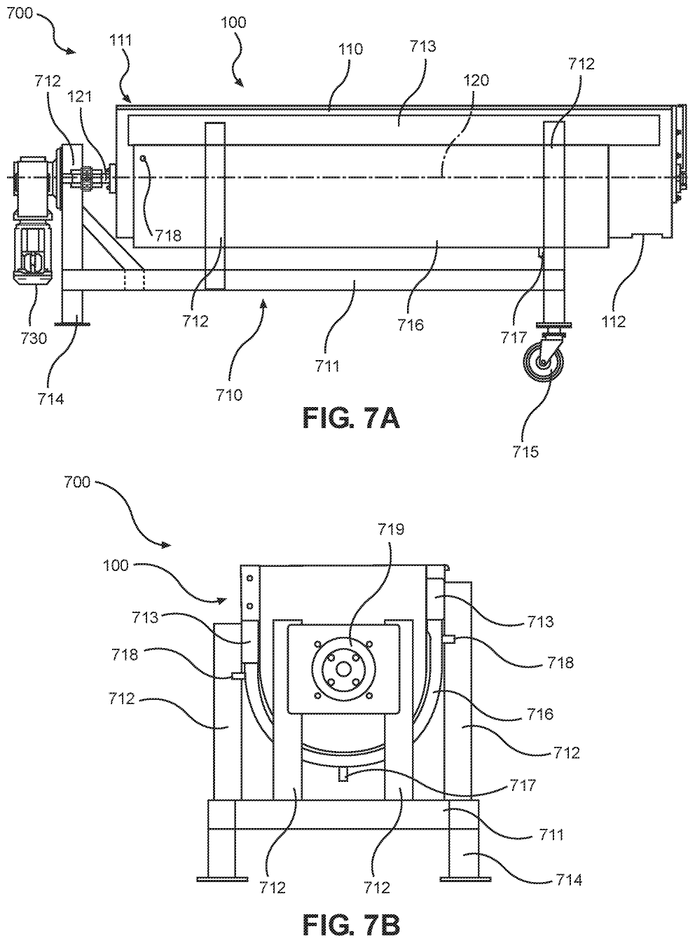

Next, FIGS. 7A and 7B illustrate an example foodstuff processing system including the foodstuff processing apparatus of FIG. 2 in side elevation and front elevation views respectively. Foodstuff processing system 700 can include foodstuff processing apparatus 100 as illustrated and described in detail above, as well as chassis 710 and other system components. Again, foodstuff processing apparatus 100 can include a material passage 110 that may take the form of a U-shaped trough having an inlet region 111 and outlet 112, as well as a rotatable inner shaft having multiple protrusions (not shown) coupled thereto and extending therefrom, among other components and features. In some arrangements, the back end of material passage 110 and outlet 112 thereat can be elevated above the bottom level for the rest of the material passage, such that water or other lightly processed foodstuff materials do not readily flow quickly along the bottom of the material passage and leak or escape through the outlet without being processed. It will be understood that besides apparatus 100, any other similarly arranged foodstuff processing apparatus disclosed herein can also be used within foodstuff processing system 700.

Chassis 710 can be configured to support foodstuff processing apparatus 100 and in some arrangements can allow for its ready transport, movement, and positioning. As such, chassis 710 can include a support frame having a platform or one or more bottom supports 711 located beneath material passage 110, one or more vertical supports 712 extending upward from the platform or bottom support(s), and one or more upper supports 713 coupled to at least some of the vertical supports and extending along the sidewalls of the material passage to prevent the material passage from rotating or falling off the chassis. One or more stanchions 714 can extend downward from platform or bottom support(s) 711 to support and elevate foodstuff processing apparatus 100 and the rest of chassis 710 above the ground or floor. Although not necessary, one or more optional wheels 715 can be coupled to one or more of stanchions 714 and can facilitate transport and movement of chassis 710 and foodstuff processing apparatus 100 held therein.

Similar to device 1 illustrated above, foodstuff processing system 700 can include a rotational motor 730 and associated controller (not shown) configured to control operation of the rotational motor, with one or both of motor and controller also being supported by chassis 710. Rotational motor 730 can be coupled to a front end portion 121 of the inner shaft that protrudes through an end cap of material passage 110 such that the rotational motor can be configured to rotationally drive the entire inner shaft. Interface arrangement 719 can be coupled to vertical supports 712 at the front end of system 700, and this interface arrangement can be configured to stably orient and support motor 730, and/or other system components. In some arrangements, a cooling jacket or other cooling system 716 can be arranged around some or all of the outer surfaces of material passage 110. Cooling system 716 can be configured to have fluid coolant circulating therethrough, and as such can have one or more coolant inlets 717 and one or more coolant outlets 718. Foodstuff processing system 700 can include additional components, features, and functions not shown, as will be readily appreciated by those of skill in the art.

Continuing with FIG. 8, a flowchart is provided of an example detailed method of processing foodstuff materials using a foodstuff processing apparatus having plowheads with driving surfaces. Method 800 can be a detailed version of method 300 above, with various steps and details being interchangeable and/or removable from one or both methods. As in the above summary method 300, various steps of detailed method 800 can be performed in different orders and/or simultaneously, such as during the continuous processing of foodstuff materials. Furthermore, some or all steps may be repeated as desired in varying orders until all desired foodstuff processing is finished.

After a start step 802, an optional first process step 804 can involve removing an existing inner shaft and its coupled extending protrusions from a material passage of a foodstuff processing apparatus. This can be done where a different arrangement of extending protrusions are desired, such as for using different foodstuff materials and/or different desired results than those that were used for the existing inner shaft and its arrangement of protrusions, for example. Alternatively, or in addition, this can be done to scale the existing foodstuff processing apparatus for reduced or greater throughputs or can simply be done to replace an inner shaft and set of extending protrusions that are worn or in need of repair or replacement.

At following optional process step 806, a replacement inner shaft and its coupled extending replacement protrusions can be installed into the material passage when an existing inner shaft and its coupled extending protrusions have been removed therefrom. In some cases, the replacement protrusions can be different from and/or arranged differently than the removed protrusions on the removed inner shaft. Again, a given inner shaft and its multiple coupled protrusions can be removed and/or installed as a combined unit, which can allow for easier modular transitions between different sets of protrusions that are designed for different foodstuff materials, processing functions, and/or product outputs. As noted above, one or more protrusions can be adjusted or replaced in lieu of removing and replacing an entire inner shaft and its full coupled set of protrusions.

At next optional process step 808, one or more rotational or other operational parameters of the inner shaft can be adjusted. This can be done where it is desirable to rotate the inner shaft faster, slower, for different time intervals, and/or in opposite or oscillating directions for any of a number of reasons. Optional step 808 can be performed when a replacement shaft with replacement protrusions has been installed or can take place for an existing inner shaft and set of protrusions that remains in place when changes in processing are desired. Step 808 can be performed automatically, such as by a controller with one or more processors that is configured to control and drive a rotational motor coupled to the inner shaft and that can operate according to set parameter scripts or procedures that are selected based on changes in foodstuff materials being used, changes in desired product outputs, detected issues during continuous processing, and/or changes in protrusions or protrusion arrangements, among other possible reasons.

Process step 810 can then involve rotating an inner shaft within the material passage, which rotation can be about a longitudinal axis extending through the material passage. This can be done using a rotational motor coupled to and configured to rotate the inner shaft. This can involve the use of an inner shaft having multiple protrusions with plowheads and other features and components such as any of those described in detail above. Step 810 can be performed automatically, such as by a controller having one or more processors that is configured to control and drive a rotational motor coupled to the inner shaft.

At process step 812, foodstuff materials can be provided into a material passage. This can involve a material passage and other features and components such as any of those described in detail above. As noted above, the foodstuff materials can be plant-based meat foodstuffs, which can include texturized vegetable protein, one or more processing aids, and/or water, for example, among other possible materials. Foodstuff materials can be provided into the material passage by way of one or more hoppers or other inlets or inlet regions into the material passage. Step 812 can be performed automatically, such as by an automated system configured to feed the foodstuff materials in dosed amounts through one or more inlets or inlet regions of the material passage.

Process step 814 can involve providing water into the material passage while the foodstuff materials are within the material passage, which can result in producing a plurality of hydrated foodstuff material particles. This can be done at the inlet where foodstuff materials are input into the materials and/or at one or more hydration ports or inlets that can be distributed along the material passage. For example, multiple sprayers can be distributed along the top of the material passage and can be configured to spray water in dosed amounts into the material passage at select locations during a continuous process where some or all of steps 810-822 are simultaneously performed. Step 814 can be performed automatically, such as by an automated system configured to provide water into the material passage in dosed amounts, at designated locations, and at programmed time intervals.

At process step 816, the foodstuff materials can be conveyed through the material passage toward its outlet. Again, such conveying can be at least partially facilitated by plowhead driving surfaces on the protrusions that push or force the foodstuff materials toward the outlet when the inner shaft and multiple protrusions are rotated about the longitudinal axis. Conveying can be performed on dry foodstuff materials, hydrated foodstuff materials, or both. Step 816 can be performed automatically, such as by way of the natural results of a design where the driving surfaces face in a particular direction and the plowheads rotate with the inner shaft when the inner shaft is automatically rotated by way of a rotational motor and controller.

At subsequent process step 818, the foodstuff materials can be agitated within the material passage. Such agitating can be at least partially facilitated by the plowheads when the inner shaft and multiple protrusions are rotated about the longitudinal axis. This can result from a driving surface of each plowhead pushing the foodstuff material it contacts as it rotates as well as a leading pointed corner at one end of the driving surface that plows or cuts into the foodstuff materials as it leads the plowhead into the foodstuff materials during rotation. Agitating can take place on dry foodstuff materials, hydrated foodstuff materials, or both. Step 818 can be performed automatically, such as by way of the natural results of a plowhead design having a driving surface and a leading pointed corner to result in material agitation when the plowheads rotate with the inner shaft when the inner shaft is automatically rotated.

Following process step 820 can involve preventing the buildup of foodstuff materials on one or more sidewalls of the material passage, such as while the foodstuff materials are being conveyed and otherwise processed through the material passage. This step can be particularly applicable where the material passage is a U-shaped trough or similar form, for example, and may not be needed where the material passage is a hollow tube. As noted above, this can be facilitated by way of one or more inserts or other suitable features being installed or incorporated into the material passage to eliminate, reduce, or otherwise prevent buildup on sidewall(s). Step 820 can be performed automatically, such as by way of the natural results of a design where foodstuff materials being pushed upward along a sidewall are diverted by insert(s) away from the sidewall such that they fall back toward the bottom and center of the material passage rather than stick to the sidewall to form buildup where the plowheads pushing the foodstuff materials move up and away from the sidewall during normal rotational motion.

At a next process step 822, foodstuff materials can be collected from the outlet of the material passage. Again, the outlet can be located through the bottom of the material passage proximate a back end thereof, although other locations are possible. Step 822 can be performed automatically, such as by using one or more added automated conveyances and/or components of an overall system that are situated outside the outlet. One or more containers, receptacles, or other items can be located outside the outlet to collect the output foodstuff materials, and such containers or other items can be moved or emptied periodically as part of an overall automated process involving other items or components in an overall foodstuff processing system.

At subsequent decision step 824, an inquiry can be made as to whether all desired foodstuff processing is finished. If not, then the method can revert to process step 810 and some or all of steps 810-824 can be repeated for further foodstuff processing. Decision step 824 can be performed automatically, such as by a controller having one or more processors configured to run a program or timed routine to control at least some automated functions and aspects of method 800. Such automated functions controlled by the controller can include, for example, providing foodstuff materials at the inlet, driving a rotational motor coupled to the inner shaft, providing water into the material passage, and/or collecting foodstuff materials at the outlet, among other possible automated functions. If all desired foodstuff processing is finished at decision step 824, then the method can end at end step 826.

Again, all steps can be performed simultaneously and in automated fashion, such that foodstuff materials can be continuously processed within and through the material passage. In addition, not all steps will be needed for some processes, such that various condensed versions of detailed method 800 can be used. Furthermore, the order of steps can be altered as may be practical or optimal for a given continuous foodstuff material processing process. For example, the method can revert to optional step 808 from step 824 such that shaft rotation parameters can be adjusted once during processing before all remaining steps can then be repeated continuously. Additional steps or functions can also be performed as may be desired. Such additional steps can include using one or more sensors to detect automatically clogs or other problems during foodstuff processing, and automatically altering or halting production when a processing problem is detected, as well as cleaning, unclogging, and/or performing maintenance on the material passage when needed, for example, among other possible process steps.

Moving next to FIG. 9, an example alternative foodstuff processing apparatus is illustrated in top plan view. Alternative foodstuff processing apparatus 900 can be similar in various ways to apparatuses 100, 101, and 102 described and illustrated above. For example, apparatus 900 can include a material passage 910, an inner shaft 920, and multiple protrusions 930 extending from the inner shaft, all of which can combine to continuously hydrate, agitate, mix, convey, and/or otherwise process foodstuff materials, such as plant-based meat analogue foodstuff materials. Material passage 910 can similarly form a U-shaped trough that can include one or more inlets 911, one or more outlets 912, a bottom, sidewalls, a longitudinal axis 915, endcaps 916, and upper flanges 917, among other items including those noted above. Inner shaft 920 can be within material passage 910, can extend along longitudinal axis 915, and can be rotationally driven about this axis. Multiple protrusions 930 can extend from inner shaft 920 and can rotate with the inner shaft when it is rotationally driven. Some or all of multiple protrusions 930 can include a post coupled to inner shaft 920 and a plowhead or other paddle type feature coupled to a distal end of the post away from the inner shaft. Each plowhead can include a driving surface that pushes foodstuff materials when inner shaft 920 is rotationally driven.

Unlike the various apparatus embodiments illustrated and described above, multiple protrusions 930 can be arranged such that some of their plowheads are oriented in different directions than other plowheads. For example, a first portion of plowheads can be oriented so that their driving surfaces are arranged at an angle with respect to longitudinal axis 915 such that these driving surfaces push foodstuff materials toward outlet 912 when inner shaft 920 is rotationally driven. This first portion of forward driving plowheads can be located in regions or zones 960 and 963 of material passage 910, for example. In some arrangements, the forward driving plowheads in one region or zone can be angled differently than the forward driving plowheads in another region or zone. For example, the plowheads in zone 963 can be angled more forward than the plowhead in zone 960.

A second portion of plowheads can be oriented so that their driving surfaces are arranged at an angle with respect to longitudinal axis 915 such that their driving surfaces push foodstuff materials backwards and toward inlet 911 when inner shaft 920 is rotationally driven. This second portion of backward driving plowheads can be located in region or zone 964 of material passage 910, for example. This particular zone 964 can be located just past outlet 912 such that its plowheads actually push foodstuff materials back toward the outlet rather than letting materials stagnate between the outlet and endcap 916. Other zones having backwards driving plowheads are also possible, such as zone 962, for example, and it will be understood that while this second portion of plowheads can be arranged such that their driving surfaces push foodstuff materials that they contact backwards, the overall mass of foodstuff materials within these zones and within the entire material passage in general will still result in a net positive overall flow or conveyance of foodstuff materials through these zones having backwards oriented plowheads, which effectively serve to slow down the overall flow in these zones.

In some arrangements, a third portion of plowheads can be oriented so that their driving surfaces are arranged to be parallel with respect to longitudinal axis 915 such that their driving surfaces push foodstuff materials toward a sidewall of material passage 910 when inner shaft 920 is rotationally driven. This third portion of sideways driving plowheads can be located in region or zone 961 of material passage 910, for example. In various embodiments, the orientation angles can vary for driving surfaces of different plowheads that are all forward driving plowheads or backward driving plowheads. For example, backward driving plowheads located within zone 961 can have their driving surfaces oriented at an angle that pushes foodstuff materials slightly backwards, while backward driving plowheads located within zone 962 can have their driving surfaces oriented at an angle that pushes foodstuff materials aggressively backwards. Although five regions or zones 960, 961, 962, 963, 964 are shown in FIG. 9, it will be readily appreciated that more or fewer zones can be implemented, and that these zones can alternate differently as may be desired, such as by having a backwards driving zone located closer to inlet 911 or front region of material passage 910.

By having such arrangements of differently oriented plowheads as shown, different conveyance and processing zones can be created within material passage 910. For example, zone 960 can form a fast zone configured to result in faster overall flow or conveyance of foodstuff materials toward outlet 912, while zones 961 and 962 can form slow zones configured to result in slower overall flow or conveyance of foodstuff materials toward the outlet. Forming different zones having different conveyance speeds can be implemented for a variety of reasons. For example, slow zones can be formed where water is being added into the material passage so that foodstuff materials can spend more time in the slow zones and have more opportunity to be sufficiently hydrated. Alternatively, water can be added into the material passage in one or more fast zones, as may be desired for a particular process. As another example, a very slow zone 962 just before the outlet 912 of material passage 910 can function to limit the amount of foodstuff materials that prematurely exit or leak out of the material passage without experiencing a sufficient amount of hydration, agitation, and/or other processing within the material passage.

Continuing with FIGS. 10A through 10C, an example alternative plowhead for a foodstuff processing apparatus is shown in top perspective, front elevation, and top plan views respectively. Alternative plowhead 1040 can define a flat paddle shape having various features that are similar to the features of triangular wedge shaped plowhead 140 detailed above. These can include a driving surface 1041 configured to push foodstuff materials, a pointed declumping corner 1042 configured to lead plowhead movement to push through foodstuff materials and break up clumps therein, and a curved top surface 1044. Flat paddle shaped plowhead 1040 can also have a thickness 1049 that can be relatively thin and uniform to minimize the overall volume of the plowhead within the material passage. Also similar to triangular wedge shaped plowhead 140 above, flat paddle shaped plowhead 1040 can have its curved top surface 1044 face a sidewall of the material passage as it rotates and a bottom surface opposite the top surface that faces the inner shaft.

Alternative plowhead 1040 can have a front surface, back surface, and thin side edges that can be disposed between top surface 1044 and its bottom surface, with driving surface 1041 being the front surface. As in the case of plowhead 140 above, top surface 1044 can define a curved surface that moves along the bottom and one or more sidewalls of the material passage at a minimal clearance therefrom as the plowhead rotates with the inner shaft, and this minimal clearance between the top surface and the bottom and one or more sidewalls of the material passage can be about 3 mm.

FIG. 10C shows alternative plowhead 1040 oriented with respect to a longitudinal axis 1015, which can be the axis of an associated rotating inner shaft. As in the case of the triangular wedge shaped plowhead 140 above, flat paddle plowhead 1040 can be coupled to one end of a post 1030 that can in turn be coupled to the inner shaft at its other end, such that the plowhead and post combine to form a protrusion extending from the inner shaft. Rotation of the inner shaft can then rotate the protrusion about the shaft such that foodstuff materials are pushed by the driving surface 1041 of plowhead 1040. In some embodiments, plowheads 1040 can be used in place of all plowheads 140 above for a given foodstuff processing apparatus. In other embodiments, a foodstuff processing apparatus can have a combination that includes some triangular wedge shaped plowheads 140 and some flat paddle shaped plowheads 1040. Other arrangements using other types and shapes of suitable plowheads are also possible.

Lastly, FIG. 11 illustrates an example alternative foodstuff processing system in top plan view. Alternative foodstuff processing system 1100 can be similar to foodstuff processing system 700 shown and described above in that it can include a foodstuff processing apparatus as well as a supporting chassis and other system components. The chassis can be identical or substantially similar to chassis 710 above, and can include upper support components 1113, stanchions 1114, and other components and features detailed above. The foodstuff processing apparatus can include a material passage 1110 having inlet 1111, outlet 1112, endcaps 1116, and upper flanges 1117, an inner shaft 1120 situated along longitudinal axis 1115, and other components and features detailed above. Multiple removable covers or lids 1170 can be placed atop material passage 1110 to keep materials being conveyed and processed within the material passage, and such lids 1170 can have inlet 1111 and one or more water inputs (not shown) along the material passage formed therethrough.

Unlike the foregoing examples, alternative foodstuff processing system 1100 can include alternative flat paddle shaped plowheads 1040 forming part of the protrusions that extend from inner shaft 1120. As suggested above, alternative plowheads 1040 can be oriented at different angles with respect to longitudinal axis 1115 such that different zones are formed along material passage 1110. For example, zone 1163 can include plowheads that are oriented such that their driving surfaces push foodstuff materials more slowly toward outlet 1112, thus forming a slow zone within material passage 1110, while zone 1164 can have one or more backwards facing plowheads that catch material that has passed the outlet and force the material back toward the outlet. Other plowheads 1040 at or near the front of material passage 1110 proximate inlet 1111 can be oriented such that their driving surfaces push foodstuff materials forwards toward outlet 1112, thus forming a fast zone within the material passage. One or more additional slow zones can be formed within the material passage to facilitate a more thorough processing of materials through such zones, which can be located where water inputs provide water into the material passage to hydrate the foodstuff materials being agitated and conveyed within the slow zones, for example.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. An apparatus configured to process foodstuff materials, the apparatus comprising:
a material passage having an inlet, an outlet, a bottom, and one or more sidewalls, the material passage defining a longitudinal axis therethrough, wherein the material passage is configured to facilitate the conveyance of foodstuff materials from the inlet to the outlet;
an inner shaft located within the material passage and extending along the longitudinal axis between the inlet and the outlet, wherein the inner shaft is configured to be rotationally driven;
one or more input regions configured for the addition of water to the foodstuff materials within the material passage to facilitate hydration thereof during conveyance to the outlet; and
multiple protrusions extending from the inner shaft and configured to rotate with the inner shaft when the inner shaft is rotationally driven, wherein each of the multiple protrusions includes a post coupled to the inner shaft and a plowhead coupled to a distal end of the post away from the inner shaft, each plowhead having a driving surface configured to push the foodstuff materials, and wherein the driving surfaces of each of at least a first portion of the plowheads are arranged at an angle with respect to the longitudinal axis such that the first portion of driving surfaces push the foodstuff materials toward the outlet when the inner shaft is rotationally driven.

2. The apparatus of claim 1, wherein the driving surfaces of each of at least a second portion of the plowheads are arranged at an angle with respect to the longitudinal axis such that the second portion of driving surfaces push the foodstuff materials toward the inlet when the inner shaft is rotationally driven.

3. The apparatus of claim 2, wherein the first portion of plowheads are arranged to result in one or more fast zones within the material passage configured to result in faster conveyance of the foodstuff materials toward the outlet and the second portion of plowheads are arranged to result in one or more slow zones within the material passage configured to result in slower conveyance of the foodstuff materials toward the outlet.

4. The apparatus of claim 3, wherein the one or more input regions are configured for the addition of water to the foodstuff materials within one or more of the fast zones.

5. The apparatus of claim 1, wherein the material passage is a U-shaped trough.

6. The apparatus of claim 5, further comprising:
one or more passive mechanical inserts extending from at least one sidewall of the U-shaped trough, wherein the one or more passive mechanical inserts minimize buildup of the foodstuff materials on the at least one sidewall.

7. The apparatus of claim 1, wherein at least a portion of the posts are each removably coupled to the inner shaft, at least a portion of the plowheads are each removably coupled to their respective posts, or both.

8. The apparatus of claim 1, wherein the inner shaft and multiple protrusions coupled thereto is configured to be removed from the material passage as a combined unit and replaced with an alternative combined unit of inner shaft and multiple protrusions.

9. The apparatus of claim 1, wherein each of the first portion of plowheads further includes a first pointed corner at a first edge of its driving surface, the first pointed corner pointing toward a sidewall of the material passage and configured to plow or cut into the foodstuff materials as the plowhead is rotationally driven therethrough.

10. The apparatus of claim 1, wherein one or more of the plowheads defines a triangular wedge shape having a top surface that faces a sidewall of the material passage, a bottom surface that faces the inner shaft, and three side surfaces between the top surface and bottom surface, with the driving surface being one of the three side surfaces.

11. The apparatus of claim 1, wherein one or more of the plowheads defines a flat paddle shape having a top surface that faces a sidewall of the material passage, a bottom surface that faces the inner shaft, and a front surface, back surface, and side edges between the top surface and bottom surface, with the driving surface being the front surface.

12. The apparatus of claim 1, wherein the top surface of at least some of the plowheads defines a curved surface that moves along the bottom and one or more sidewalls of the material passage at a minimal clearance therefrom as the plowheads rotate with the inner shaft.

13. The apparatus of claim 12, wherein the minimal clearance between the top surfaces of the plowheads and the bottom and one or more sidewalls of the material passage is about 3 mm.

14. The apparatus of claim 1, wherein the material passage, the inner shaft, and the multiple protrusions are all interchangeable with similar components to facilitate scalability of the apparatus for different foodstuff materials, variable outputs, or other production parameters.

15. A method of processing foodstuff materials, the method comprising:
providing foodstuff materials into a material passage having at least a bottom, one or more sidewalls, and an outlet, the material passage defining a longitudinal axis therethrough;
rotating an inner shaft within the material passage about the longitudinal axis, the inner shaft having multiple protrusions extending therefrom that rotate with the inner shaft, wherein each of the multiple protrusions includes a post coupled to the inner shaft and a plowhead coupled to a distal end of the post away from the inner shaft, each plowhead having a driving surface configured to push the foodstuff materials, and wherein the driving surfaces of each of at least a first portion of the plowheads are arranged at an angle with respect to the longitudinal axis such that the first portion of driving surfaces push the foodstuff materials toward the outlet when the inner shaft is rotationally driven;
inputting water into the material passage while the foodstuff materials are within the material passage to produce a plurality of hydrated foodstuff material particles;
conveying the foodstuff materials through the material passage toward the outlet, wherein the conveying is at least partially facilitated by the first portion of driving surfaces pushing the foodstuff materials toward the outlet when the inner shaft and multiple protrusions are rotated about the longitudinal axis;
agitating the foodstuff materials while the foodstuff materials are within the material passage; and
collecting the foodstuff materials from the outlet of the material passage.

16. The method of claim 15, wherein each of the steps of providing, rotating, inputting, conveying, agitating, and collecting is performed automatically by an automated system.

17. The method of claim 15, wherein the agitating is at least partially facilitated by the plowheads when the inner shaft and multiple protrusions are rotated about the longitudinal axis.

18. The method of claim 15, wherein the driving surfaces of each of at least a second portion of the plowheads are arranged at an angle with respect to the longitudinal axis such that the second portion of driving surfaces push the foodstuff materials toward the inlet when the inner shaft is rotationally driven, the first portion of plowheads being arranged to result in one or more fast zones within the material passage configured to result in faster conveyance of the foodstuff materials toward the outlet and the second portion of plowheads being arranged to result in one or more slow zones within the material passage configured to result in slower conveyance of the foodstuff materials toward the outlet.

19. The method of claim 15, further comprising:
preventing buildup of the foodstuff materials along the one or more sidewalls as the foodstuff materials are conveyed through the material passage.

20. The method of claim 15, further comprising:
removing the inner shaft and multiple protrusions coupled thereto from the material passage; and
installing a replacement inner shaft having replacement protrusions coupled thereto into the material passage, wherein the replacement protrusions are arranged differently than the removed multiple protrusions on the removed inner shaft.
